(19) United States
(12) Patent Application Publication
(10) Pub. No.: US 2024/0408853 A1
(43) Pub. Date: Dec. 12, 2024

(54) AUTOMOTIVE LAMINATE GLAZING WITH IMPROVED OPTICAL QUALITY

(71) Applicant: AGP WORLDWIDE OPERATIONS GMBH, Zug (CH)

(72) Inventors: Amey Nitin KENJALE, Baesweiler (DE); Frank Antony HUAMÁN PIO, Lima (PE); Merlyn ROJAS VALLE, Lima (PE); Jorge Alexis RAMOS MUÑOZ, Lima (PE); Vincenzo MANNINO, Lima (PE)

(21) Appl. No.: 18/718,032

(22) PCT Filed: Dec. 9, 2022
(86) PCT No.: PCT/IB2022/062012

§ 371 Date: Jun. 8, 2024

Related U.S. Application Data
(60) Provisional application No. 63/287,968, filed on Dec. 9, 2021.

(51) Int. Cl. B32B 17/10

(52) U.S. Cl. CPC B32B 17/10036; B32B 17/10293; B32B 17/10385; B32B 17/10559; B32B 2250/03; B32B 2305/347; B32B 2605/00

(57) ABSTRACT

The present disclosure is directed to a curved automotive laminated glazing with an opening, named cutout, in the performance plastic interlayer, such that the edges of said cutout has improved optical properties. Conventionally an opening must be provided onto the performance plastic interlayer such as UV absorbing. IR reflective or other types of solar performance interlayers to aiming to remove any optical disruptions. However, it was discovered that the geometry of the cutout in the performance interlayer plays an important role in the optical distortion measured in the center of the field of view. Therefore, the present invention suggests the use of a cutout geometry having round corners which decrease the optical distortion in the field of view by a factor of three.

### FIELD OF THE INVENTION

The invention relates to the field of automotive glazing with improved optical quality.

### BACKGROUND OF THE INVENTION

In the last decade, automotive glazing with information acquisition device such as safety cameras are becoming more popular as a way to increase the safety of the car occupants and the others on the road. Safety cameras require a field of view, that is, the region of the glazing where cameras are installed facing the road, which should be free of optical distortion to operate. Optical distortion is caused normally by either thermal stresses on the glass layers or by surface unevenness of the interlayers.

Therefore, cameras are preferably installed on the glazing region with a minimum curvature. It is also common practice to provide a cutout in the interior glass layer, the glass layer that faces the interior of the vehicle for the camera to be able to capture the image that goes through the smallest optical path possible inside the glazing, for instance, just one layer of glass and preferably fewer plastic interlayers.

Black ceramic frit, also known as obscuration band, is also responsible for causing optical distortion. This is due to the thermal stresses caused on regions adjacent to the frit when it is cured or vitrified and cooled down. The black ceramic frit is normally applied on at least one of the glass layers of the laminate, not only around the glazing perimeter to conceal and protect the adhesives that attach the glazing to the vehicle, but also to conceal other electronic features such as the rain sensor or around the camera region to hide the camera electronics and bracket from the exterior view. The ceramic black frit distortion has been solved in the prior art by proposing other types of paint such as organic paint that does not require curing at high temperatures or by proposing black opaque interlayers around the camera region.

The laminating plastic interlayers also play a role in generating optical distortion and affecting the safety camera operation. Not only the type of interlayers should be carefully chosen to provide a clear view such as increased light transmission, but also the lamination process should be well controlled to achieve an even lamination surface, free of wrinkles and bubbles.

It would be desirable to overcome these limitations by providing a laminated glazing with superior optical quality and performance, more specifically, providing a zone of plastic interlayer with low formation of wrinkles, more particularly by those formed by the performance layers.

### DESCRIPTION OF THE DRAWINGS

FIGS. 1A and 1B show a cross section of a typical automotive laminated glazing.

FIGS. 2A-2F show a cross section of a laminated glass according to several embodiments of the invention.

FIGS. 3A-3E show a cross section of a laminated glass according to several embodiments of the invention.

FIGS. 4A and 4B illustrate different performance interlayer cutout shapes.

FIGS. 5A-5C show the result of optical distortion measurements.

### REFERENCE NUMBERS

2 Glass layer
4 Plastic bonding interlayer
6 Obscuration
8 Cutout
10 Adhesive layer
12 Performance interlayer
14 Insert
16 Second performance interlayer
18 Functional coating
20 Compensation layer
101 Surface one of the exterior glass layer
102 Surface two of the exterior glass layer
103 Surface three of the interior glass layer
104 Surface four of the interior glass layer
201 Exterior glass layer
202 Interior glass layer

### BRIEF SUMMARY OF THE INVENTION

The present invention provides an automotive laminated glazing, more specifically, provides for a curved automotive laminated glazing with an opening for information acquisition sensor device with improved optical properties. The invention comprises an exterior glass layer, an interior glass layer, at least one performance interlayer disposed between the exterior and the interior glass layers. Said at least one performance interlayer has at least one cutout having a shape geometry with round corners. The laminated glazing also comprises at least two plastic bonding interlayers each serving to bond said at least one performance interlayer to said exterior and said interior glass layers.

### DESCRIPTION OF THE INVENTION

The following terminology is used along the whole document to describe the features of the invention.

The term “layer”, as used in this context, shall include the common definition of the word, i.e.: a sheet, quantity, or thickness, of material, typically of some homogeneous substance.

The term “glass substrate” or “glass pane” should be understood as a sheet, quantity, or thickness of material, typically of some homogeneous substance. The “glass substrate or pane” may comprise one or more layers.

The term “glass” can be applied to many organic and inorganic materials, including many that are not transparent. From a scientific standpoint, “glass” is defined as a state of matter comprising a non-crystalline amorphous solid that lacks the ordered molecular structure of true solids. Glasses have the mechanical rigidity of crystals with the random structure of liquids.

The term “glazing” should be understood as a product comprised of at least one layer of a transparent material, preferably glass, which serves to provide for the transmission of light and/or to provide for viewing of the side opposite to the viewer and which is mounted in an opening in a building, vehicle, wall or roof or other framing member or enclosure.

The terms “glass pane” and “laminated glass pane” refer respectively to a glazing having one glass layer and to a laminated glazing having at least two glass layers.

“Laminates”, in general, are products comprised of multiple sheets of thin, relative to their length and width, material, with each thin sheet having two oppositely disposed major faces and typically of a relatively uniform thickness, which are permanently bonded to each other across at least one major face of each sheet.

The present invention provides a laminated glass with a cutout in the performance plastic interlayer such that the edges of said cutout has improved optical properties. Specifically, the laminated glass comprises an exterior glass layer, an interior glass layer, at least one performance interlayer disposed between the exterior and the interior glass layers, wherein said at least one performance interlayer has at least one cutout having a shape geometry with round corners, and at least two plastic bonding interlayers each serving to bond said at least one performance interlayer to said exterior and said interior glass layers.

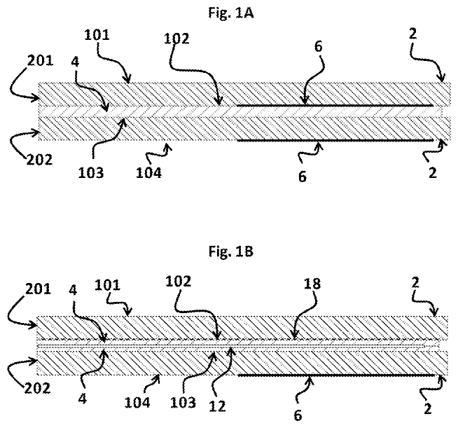

Typical automotive laminated glazing cross sections is illustrated in FIGS. 1A and 1B. A laminate glazing is comprised of at least two layers of glass, the exterior or outer 201 and interior or inner 202 that are permanently bonded together by a plastic bonding layer 4 (interlayer). In a laminate, the glass surface that is on the exterior of the vehicle is referred to as surface one 101, or the number one surface. The opposite face of the outer glass layer 201 is surface two 102, or the number two surface. The glass surface that is on the interior of the vehicle is referred to as surface four 104, or the number four surface. The opposite face of the inner layer of glass 202 is surface three 103, or the number three surface. Surfaces two 102, and three 103, are bonded together by the plastic layer 4. An obscuration 6 may be also applied to the glass. Obscurations are commonly comprised of black enamel frit printed on either the number two, 102, or number four surface 104 or on both. The laminate may have a functional coating 18 on one or more of the surfaces. For instance, a functional coating 18 is conventionally applied onto surface 102, 103, 104 or a combination thereof. Coatings that are conventionally used in automotive glazing are any of the following or a combination of solar-control, heating, anti-reflective, polarization control and color control. The laminate may also comprise a performance film 12 laminated between at least two plastic layers 4.

Plastic bonding layer interlayer 4 has the primary function of bonding the major faces of adjacent layers to each other. These major faces can also be called inner surfaces of the first glass layer and the second glass layer, respectively. In other words, the inner surface of the first glass layer is bonded with the inner surface of the second glass layer. Plastic bonding interlayer 4 is used as a bonding layer selected from the group consisting of polyvinyl butyral (PVB), ethylene vinyl acetate (EVA), and thermoplastic polyurethane (TPU). Typical automotive plastic bonding layers have thickness in the range of at least 0.10 mm, more preferably at least 0.30 mm, such as 0.38 mm or 0.76 mm. Thicker plastic bonding layers may be commercially available and applicable to the laminate of the present invention.

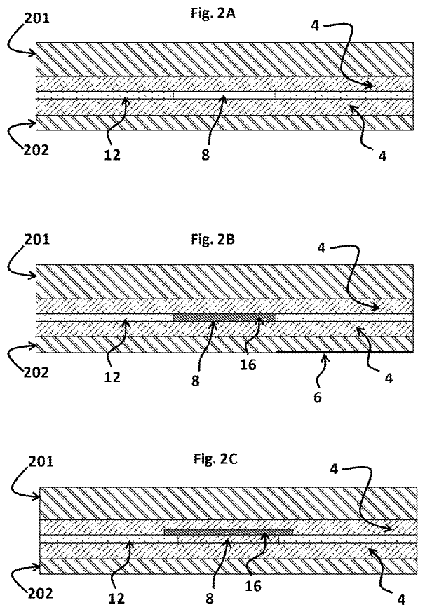

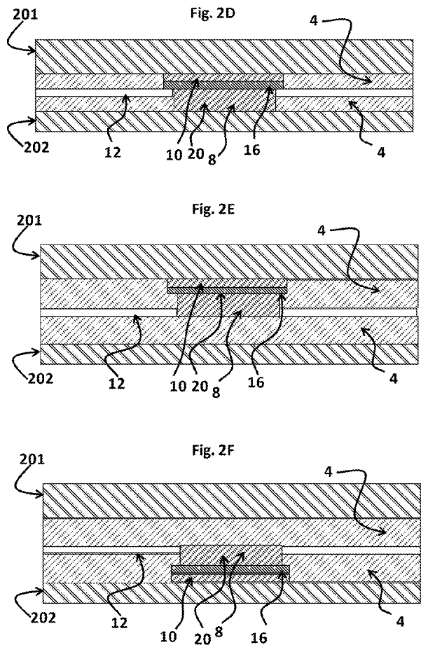

FIG. 2A illustrates an embodiment of this invention. The automotive glazing is similar to FIG. 1B and comprises an exterior glass layer 201 and an interior glass layer 202. A performance interlayer 12 is sandwiched between the two glass layers by using a first plastic interlayer 4 between the exterior glass layer 201 and the performance layer 12, and a second plastic interlayer 4 between the performance interlayer 12 and the interior glass layer 202.

The thickness of the at least one glass layer may vary widely and thus be ideally adapted to the requirements of the individual cases. In an embodiment, the thickness of the at least one glass layer of the glazing of the invention is lower than 5 mm, preferably comprised between 0.3 mm and 5.0 mm, such as between 0.5 mm and 4.0 mm or between 1.0 mm and 3.0 mm. Possible examples of thicknesses of the at least one glass layer are about 1.5 mm, 1.6 mm, 1.7 mm, 1.8 mm, 1.9 mm, 2.0 mm, 2.1 mm, 2.2 mm, 2.3 mm, 2.4 mm, 2.5 mm, 2.6 mm, 2.7 mm, 2.8 mm, 2.9 mm or 3.0 mm. More preferably, the glass layer is about 2.1 mm thick soda-lime glass layer, including ultra-clear, clear or green soda-lime.

Typical thickness of exterior glass layers for automotive applications are in the range of 5.00 mm to about 2.00 mm. Interior glass layers thickness is usually selected from 2.30 mm to 0.50 mm. However, this is not a limitation.

Glass compositions such as borosilicate or soda lime glass can be used as the exterior glass layer 201. For the interior glass layer 202, compositions such as soda lime or aluminosilicate glass are the most commonly used. However, this is not a limitation. Any of the glass compositions selected from borosilicate, soda lime and aluminosilicate can be used in any position of the laminated glazing. The exterior glass layer could be tempered, semi-tempered or annealed, whereas the interior glass layer could be either semi-tempered, chemically strengthened or annealed.

The performance interlayer 12 provides specific solar and optical properties to the glazing such as UV protection, IR reflection, or other desired performance. In one embodiment of the invention, the performance interlayer 12 is an ultraviolet (UV) light absorbing film and/or IR reflective film, for example a polyethylene (PET) based film. In another embodiment of the invention, the performance interlayer 12 is a HUD p-polarized film, HUD hologram film, a reflective film for displays, or a mechanical strength protection film.

The performance interlayers of the invention are incompatible with data acquisition devices or displays, due to the fact that they remove part of the light spectrum that these devices or displays might require to operate. In the case of a safety camera, the performance interlayer blocks part of the light spectrum that the camera should capture to form the image. Therefore, a cutout 8 must be provided on the performance interlayer. The cutout is an aperture, such as an opening made onto the performance interlayer and allows for data acquisition devices or displays to be positioned in such a way that they face the cutout. However, when a cutout is made into a performance interlayer such as a UV absorbing or IR reflective PET, optical distortion on the edges around the cutout region is generated. This optical distortion is caused mainly due to wrinkles that are formed in the interlayers during the lamination process.

It is known that plastic performance interlayers such as PETs and other interlayers that have low amounts of plasticizer or even no plasticizer, are less pliable than plastic bonding layers such as conventional PVB and tend to shrink during the lamination process.

It has been surprisingly found a relation between the geometry of the cutout in the performance interlayer 12 and the optical distortion caused on the glazing. Cutouts made in interlayers, specifically on low-plasticizer interlayers having geometries with sharp corners, such as squares, rectangles, trapezoids, and other polygons, concentrate wrinkles at the corners.

The present invention discloses a cutout geometry with round corners that avoids the generation of wrinkles. In particular embodiments, the round corners of the present invention may have a radii of curvature of at least 3 mm, more preferably more than 5 mm, 10 mm, and more preferably more than 15 mm.

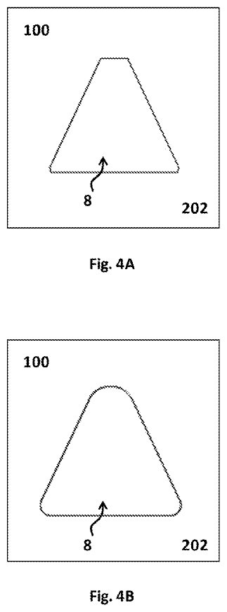

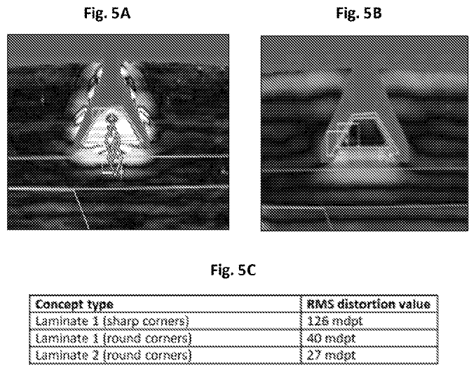

FIG. 5A shows the results of optical measurements on a real part automotive laminate glazing using a UV absorbing PET, as the performance interlayer, and a cutout in the camera field of view having a trapezoidal shape with sharp corners, such as that illustrated in FIG. 4A. The bright highlights in the regions around the cutout edges indicate regions of optical distortion in contrast to the black background away from the cutout edges, which means no distortion. The Table in FIG. 5C shows that the bright highlights achieve a RMS distortion value of 126 mdpt (milidiopters).

FIG. 5B shows the results of optical measurement on a glazing using a UV absorbing PET as the performance interlayer and also a cutout in the performance interlayer having a geometry with rounder corners. The figure shows that the round corners alleviates optical distortion generated by the performance interlayer features while the elements of the laminate were kept similar to those of FIG. 5A.

A measurement of the optical distortion in the center of the cutout, which in this case is the center of the field of view, is shown in the table of FIG. 5C. FIG. 5A corresponds to the measurement called Laminate 1 (sharp corners), and respectively FIG. 5B corresponds to the measurement called Laminate 1 (round corners). The measurements were performed in a real automotive windshield part installed at an angle of about 17 degrees, vertical with respect to the measuring camera. Other cutout geometry shapes could also be used to improve the optical distortion in the glazing camera field of view such as round corners polygons, oval or circular shapes.

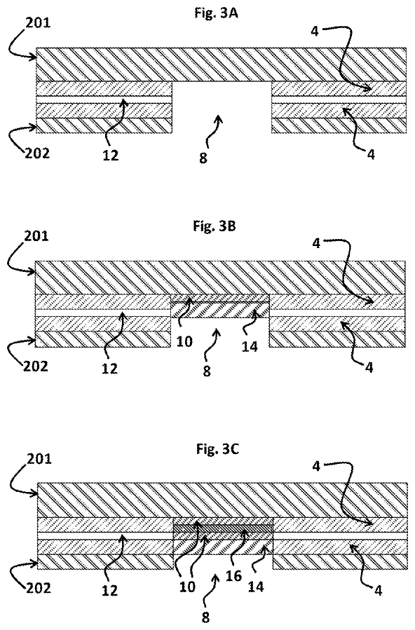

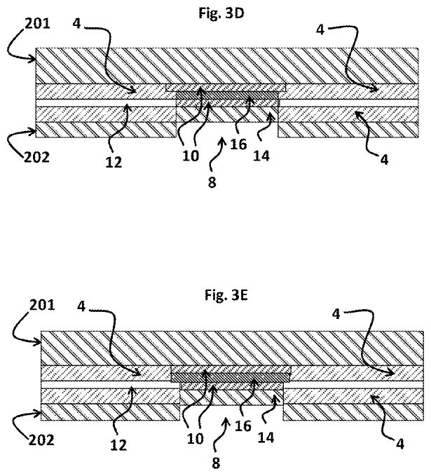

For the sake of comparison, a small sample was prepared having a cutout 8 in the performance layer 12 as well as in the interior glass layer 202, similar to the embodiment illustrated in FIG. 3A. In this case the optical distortion measured in the center of the field of view shown in the table of FIG. 5C as named Laminate 2 (round corners) is significantly lower compared to the other measurements.

In additional embodiments, a second performance interlayer 16, could be positioned in the cutout region. Such performance layer may be comprised by any of the elements of a resistive heating circuit, IR protection, polarization filter, HUD hologram, p-polarized HUD film, LIDAR camera performance enhancing interlayer, reflective film for displays or the combination thereof. One embodiment including a second performance layer 16 is illustrated on FIGS. 2B-2F, and 3C-3E.

Resistive heating circuits may be comprised of those that could be used as conductive coated films such as non-metallic heating PET or micro-wire mesh circuit embedded onto a film forming a heating patch. In one embodiment, the resistive heated circuits could have a thickness in the range of 30 μm to 180 μm and could be directly embedded in one of the glazing plastic interlayers such as a plastic bonding layer.

In another embodiment, the resistive heating circuit or any other second performance interlayers 16, could be bonded to either the interior or exterior glass layers, by means of additional thin plastic bonding layers such as those already described, for instance, PVB, EVA, TPU, or adhesives 10, such as optical clear adhesives (OCA), optical clear resins (OCR), liquid optical clear adhesives (LOCA), liquid plasticizer, pressure sensitive adhesives (PSA) or a combination thereof.

An obscuration may be printed on one or more glass layers to hide camera mounting brackets, acquisition data devices electronics and cables as well as resistive heating circuit electronic connectors. Additionally, or in place of the obscuration on the glass layers, an obscuration can be printed on one or more layers of the plastic interlayers or onto one or more plastic bonding layers of the glazing such as demonstrated in the prior-art print in the following US Patents U.S. Pat. Nos. 10,780,674 and 10,710,340. Additionally, opaque plastic inserts can be used as obscurations. In additional embodiments, a cutout in the interior glass layer may be provided. In this case, an insert 14 can be positioned in the cutout 8 to provide either mechanical resistance to the opening or to provide additional optical properties. In this sense the insert materials may comprise a thin sheet of glass or plastic material that fits or partially covers the cutout 8, such as that illustrated by the embodiments on FIGS. 3B-3E.

In the present invention the cutout region is understood as the same as an opening that is optionally filled with specific material as described in the description of several embodiments. Therefore, both terms will be used interchangeably.

The term vehicle in the present invention includes, but is not limited to, road vehicles (e.g. cars, busses, trucks, agricultural and construction vehicles, cabin motorbikes), railway vehicles (e.g. locomotives, coaches), aircraft (e.g. airplanes, helicopters), boats, ships and the like. For instance, the vehicle may be a road vehicle and more particularly a car.

### Description of Embodiments

The following is a set of examples that are proposed to illustrate the concepts of this invention.

1. Embodiment one is a curved automotive laminated glazing comprising an exterior 3.5 mm tempered soda-lime glass layer 201, laminated with an interior 0.7 mm aluminosilicate glass layer 202, chemically tempered with a set of plastic interlayers. This set of interlayers is comprised of a 0.18 mm UV absorbing PET performance plastic interlayer 12, which is sandwiched between two transparent 0.76 mm PVB bonding interlayers 4. A cutout 8 is provided in the performance plastic interlayer 12, as illustrated in FIG. 2A. The cutout shape is a trapezoid with round corners. The radius of curvature of cutout upper corner is 40 mm whereas the radii of curvature of the cutout lower corners is 20 mm each corner. The cutout in the performance interlayer 12 is filled by any one of the two PVB bonding interlayers during the lamination process. By consequence, no gap remains in the final product in the cutout region.

2. Embodiment two is similar to embodiment one except that a second performance interlayer 16, such as a resistive heating circuit with thickness in the range of 30 to 180 μm is positioned in the cutout region of the UV absorbing PET such that it fits inside the cutout 8 as illustrated in FIG. 2B. An obscuration 6 is printed onto the interior glass layer 202 made of aluminosilicate and is aligned with the delimitation of the cutout region. A second obscuration is printed onto one or both PVB interlayers 4, aligned with the delimitation of the cutout region (obscurations not shown).

3. Embodiment three is similar to embodiment two, except that the performance layer 16 is equal or larger than the cutout region 8 and therefore is positioned either above or below the cutout region 8 as illustrated in FIG. 2C. The cutout region is filled with PVB from either one of two the plastic bonding interlayers 4, or by at least one compensation layer.

4. Embodiment four is similar to embodiments two or three, further comprising a second cutout in either one of the two PVB bonding interlayers 4, the one bonded to the interior glass layer 202 or the one bonded to the exterior glass layer 201, such that the second cutout is aligned with the cutout 8 in the UV absorbing PET performance interlayer 12. At least one compensation layer 20 is inserted to fill one or both cutouts. An adhesive layer 10 may be used to bond the resistive heating circuit 16 to either the interior or the exterior glass layers 202 and 201 respectively. FIGS. 2D and 2F may be used to illustrate this embodiment.

5. Embodiment five is similar to embodiments two or three, further comprising a second and a third cutouts each onto one of the PVB bonding interlayers 4 whereas the second and third cutouts are aligned with the cutout in the UV absorbing PET performance interlayer 12. The performance layer 16, which may be a resistive heating circuit is bonded to the exterior glass layer 202 by means of an adhesive 10, such as one or a combination of a thin PVB, optical clear adhesive, optical clear resin, liquid optically clear adhesive, liquid plasticizer and/or pressure sensitive adhesive. At least one compensation layer 20 is inserted to fill one or both cutouts, as illustrated in FIG. 2D.

6. Embodiment six is similar to embodiment one, further comprising a cutout 8 in the two PVB interlayers 4 and in the interior glass layer 202, such as illustrated in FIG. 3A.

7. Embodiment seven is similar to embodiment six, further comprising an insert 14, such as a thin plastic layer for mechanical protection is disposed in the cutout region bonded to the exterior glass layer 201, by means of an adhesive 10, such as one or a combination of a thin PVB layer, optical clear adhesive, optical clear resin, liquid optically clear adhesive, liquid plasticizer and/or pressure sensitive adhesive, similar to the embodiment illustrated in FIG. 3B. The adhesive layer 10 has similar or larger dimensions than the insert 14, whereas the resistive heating circuit 16 has similar dimensions of the cutout 8.

8. Embodiment eight is similar to embodiment seven, further comprising a resistive heating circuit 16, bonded to the exterior glass layer 201 in the cutout region and sandwiched between the exterior glass layer 201 and the insert 14, such as illustrated in FIG. 3C. The insert 14 is bonded to the heating resistive circuit by means of an adhesive 10, and the resistive heating circuit is bonded to the exterior glass layer 201 similarly to the insert, by means of another adhesive layer 10, this one having similar or larger dimensions than the resistive heating circuit 16. The resistive heating circuit 16 has similar or larger dimensions than the cutout 8. This is illustrated in FIGS. 3C, 3D and 3E.

9. Embodiment nine is similar to embodiments one through eight, except that the exterior glass layer is a borosilicate glass layer.

10. Embodiment ten is similar to embodiments one through nine, except that the exterior glass layer is semi-tempered or annealed.

11. Embodiment eleven is similar to embodiments one through ten, except that the exterior glass layer 202 has a thickness in the range of 5.00 mm to 2.00 mm.

12. Embodiment thirteen is similar to embodiments one through eleven, except that the interior glass layer is a soda-lime glass layer.

13. Embodiment thirteen is similar to embodiments one through twelve, except that the interior glass layer is annealed.

14. Embodiment fourteen is similar to embodiments one through thirteen, except that the interior glass layer has a thickness in the range of 2.30 mm to 0.50 mm.

15. Embodiment fifteen is similar to embodiments one through fourteen, except that the adhesive layer is selected from the group of optical clear adhesives (OCA), optical clear resins (OCR), liquid optical clear adhesives (LOCA), liquid plasticizer, pressure sensitive adhesives (PSA) or a combination thereof.

16. Embodiment sixteen is similar to embodiments one through fifteen, except that the performance interlayer 12 is selected from the group of ultraviolet light absorbing plastic film, IR reflective plastic film, a HUD p-polarized film, HUD hologram film, a reflective film for displays or a mechanical strength protection film.

17. Embodiment seventeen is similar to embodiments one through sixteen, and further comprises a sensor window for information acquisition device, more specifically, may comprise a safety camera attached to the glazing facing the cutout region, which serves as a sensor window.

18. Embodiment eighteen is similar to embodiments one through sixteen, except that the second performance interlayer 16 is selected from the group of IR protection, polarization filter, HUD hologram, p-polarized HUD film, LIDAR camera performance enhancing interlayer, and reflective film for displays.

19. Embodiment nineteen is similar to embodiments one through eighteen, further comprising a functional coating 18 on any of the glass surface layers 102, 103, 104, or a combination thereof.

1. An automotive laminated glazing, comprising:
an exterior glass layer;
an interior glass layer;
at least one performance interlayer disposed between the exterior and the interior glass layers, wherein said at least one performance interlayer has at least one cutout having a shape geometry with round corners; and
at least two plastic bonding interlayers each serving to bond said at least one performance interlayer to said exterior and said interior glass layers.

2. The automotive laminated glazing of claim 1, wherein said cutout has a trapezoidal shape.

3. The automotive laminated glazing of claim 1, wherein the cutout round corners have a radii of curvature of more than 3 mm, more preferably more than 5 mm, 10 mm, and more preferably more than 15 mm.

4. The automotive laminated glazing of claim 1, further comprising a second performance interlayer selected from the group of: resistive heating circuit, IR protection, polarization filter, HUD hologram film, p-polarized HUD film, LIDAR camera performance enhancing interlayer, disposed in the cutout region and the combination thereof.

5. The automotive laminated glazing of claim 4, wherein the second performance interlayer is bonded to the exterior glass layer by at least one adhesive layer selected from the group of: PVB, EVA, TPU, OCA, OCR, LOCA, PSA, cured liquid plasticizer, or the combination thereof.

6. The automotive laminated glazing of claim 1, wherein the interior glass layer and one or more of said at least two plastic bonding interlayers have at least one cutout aligned with the corresponding cutout in the at least one performance interlayer.

7. The automotive laminated glazing of claim 1, wherein the at least two plastic bonding interlayers have at least one cutout aligned with that of the at least one performance interlayer.

8. The automotive laminated glazing of claim 4, wherein the second performance interlayer has either similar or larger dimension than the cutout.

9. The automotive laminated glazing of claim 4, further comprising an insert bonded to the second performance interlayer, wherein the insert material is selected from the group of plastic or glass.

10. The automotive laminated glazing of claim 1, wherein the at least one performance interlayer is selected from the group of ultraviolet light absorbing plastic film, IR reflective plastic film, a HUD p-polarized film, HUD hologram film, a reflective film for displays, a mechanical strength protection film or a combination thereof.

11. The automotive laminated glazing of claim 4, wherein the second performance interlayer is a resistive heating circuit, which is comprised of a resistive conductive coated film or micro-wire mesh patch.

12. The automotive laminated glazing of claim 1, wherein said glazing is a windshield or a panoramic windshield.

13. The automotive laminated glazing of claim 1, further comprising an information acquisition device such as safety camera or a LIDAR system facing the cutout.

14. The automotive laminated glazing of claim 4, further comprising at least one compensation layer, wherein said at least one compensation layer is a plastic interlayer disposed between the second performance interlayer and the interior glass layer.
